(19) United States
(12) Patent Application Publication
(10) Pub. No.: US 2004/0080649 A1
(43) Pub. Date: Apr. 29, 2004

(54) CMOS image sensor single chip integrated with a micro processing unit

(76) Inventor: Kuan-Ching Chang, HsinChu City (TW)

Correspondence Address: BIRCH STEWART KOLASCH & BIRCH, PO BOX 747, FALLS CHURCH, VA, 22040-0747, US

(21) Appl. No.: 10/687,872

(22) Filed: Oct. 20, 2003

(30) Foreign Application Priority Data
Oct. 21, 2002 (TW) 091216832

(51) Int. Cl. H04N 3/14

(52) U.S. Cl. 348/308

(57) ABSTRACT

The present invention discloses a CMOS image sensor single chip integrated with a micro processing unit utilizing CMOS technology. The invention integrates CMOS image sensor and micro processing unit and can process an image directly which is detected by the CMOS image sensor for different applications.

### FIELD OF THE INVENTION

The present invention generally relates to a CMOS image sensor single chip, and more particularly to a CMOS image sensor single chip integrated with micro processing unit.

### BACKGROUND OF THE INVENTION

Currently, due to the serious short supply causing by huge market requirements of image sensor, the image sensor market which the CCDs (charge coupling devices) give the first place in past has gradually been invaded by the CMOS (Complementary Metal Oxide Semiconductor) image sensor. In the future, CMOS image sensors are expected to surpass CCDs in quantity, because of the integration with the CMOS manufacturing process. The advantage of integration of CMOS manufacturing process in high degree makes the CMOS image sensors can integrate with other devices in a single chip.

CMOS image sensor, is mainly constructed with CMOS sensing array, readout circuit, pre-amplify unit and analog to digital converter (ADC). Due to use of the CMOS process, these devices can be fabricated in a single chip in general.

However, the current CMOS image sensors are mainly used for the image capturing for digital cameras and the action identification. In general, the CMOS image sensors having more pixels are for the market of the digital camera, while the CMOS image sensors having fewer pixels are for the market of action identification. Nevertheless, even though the CMOS image sensors have the possibility to integrate with other devices, there are still no related products of such system on a chip. Therefore, there is much developing space in the design of the CMOS image sensor in the future.

### SUMMARY OF THE INVENTION

It is a primary object of the present invention to provide a CMOS image sensor single chip integrated with a micro processing unit, to reduce the fabrication cost substantially.

According to the disclosed technology of the invention, the CMOS image sensor single chip integrated with a micro processing unit of the invention, comprises: a CMOS image sensor and a micro processing unit. In which, the CMOS image sensor receives the input light and transfers the light signal to the voltage signal, and further transfers the voltage signal to the image signal through the read-out in the circuit of the sensor. The micro processing unit receives the image signal, and further process the image signal through firmware in the micro processing unit to be the application signal wanted to use.

The CMOS image sensor comprises a linear image sensor, a readout circuit, a timing control circuit and a analog to digital converter (ADC). The linear image sensor is used for transferring the received input light to the sensing voltage. Then, the readout circuit comprising the column-readout circuit and the row-readout circuit reads the sensing voltage and outputs to be the image signal. The ADC is used for transferring the image signal to the digital image signal. The action timing of the exposure action in the linear image sensor and action timing of the readout action in the readout circuit (the column-readout circuit and the row-readout circuit) are controlled by the timing control circuit. However, the timing control circuit can be also integrated into the function of the micro processing unit.

On the application, different firmware are used in accordance to the different application types. For example, image compression and de-compression module, barcode-decoding module and voice transforming module.

Different firmware programs make the present invention have different application in different areas.

Other objects, advantages, and novel features of the invention will become more apparent from the following detailed description when taken in conjunction with the accompanying drawing.

### BRIEF DESCRIPTION OF THE DRAWINGS

FIG. 1 illustrate the functional blocks of the CMOS image sensor single chip integrated with the micro processing unit of the invention;

FIG. 2 illustrates the first application example of the CMOS image sensor single chip integrated with the micro processing unit of the invention;

FIG. 3 illustrates the second application example of the CMOS image sensor single chip integrated with the micro processing unit of the invention;

FIG. 4 illustrates the third application example of the CMOS image sensor single chip integrated with the micro processing unit of the invention; and

FIG. 5 illustrates the fourth application example of the CMOS image sensor single chip integrated with the micro processing unit of the invention.

### DETAILED DESCRIPTION OF THE PREFERRED EMBODIMENT

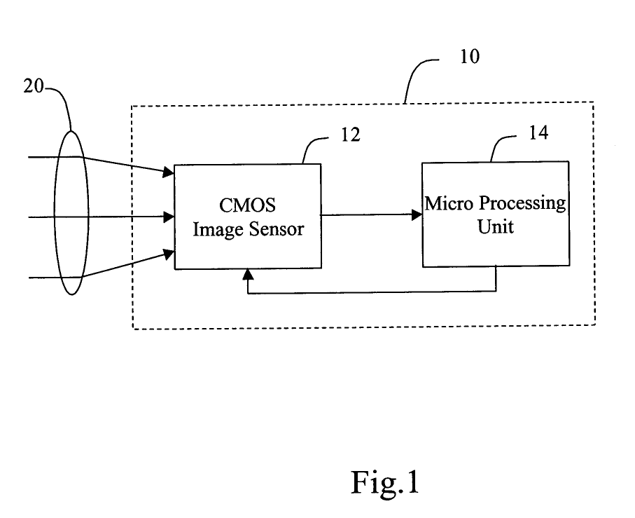

Please refer to FIG. 1, showing the function block of the present invention. The CMOS image sensor single chip integrated with the micro processing unit 10 is formed of two main parts: the CMOS image sensor 12 and the micro processing unit 14. The CMOS image sensor 12 is responsible for receiving the input light from outside part, namely, the incoming light transmitted from the lens 20. After receiving the input light, the CMOS image sensor 12 transfers the input light to sensing voltage which is transferred the sensing voltage to the image signal through the circuit among the sensor. The micro processing unit 14 receives and transforms the image signal according to the firmware programs for further control and application.

CMOS image sensor 12 can use two types: the image sensing array and linear image sensor of FIG. 1, both can be designed as different application. The image sensing array can be used for image access of more pixels or action identification of fewer pixels, while the linear image sensor can be used for various usages such as barcode reader. No matter what kind of image sensor can use the single chip framework of the present invention. The following will describe individually.

First, Image Sensing Array:

As the image sensor is illustrated in FIG. 1, the framework can be: an image sensing array, a readout circuit, a timing control circuit and an analog to digital converter (ADC). The image sensing array is used for transferring the received input light to the sensing voltage. Then, the readout circuit comprising the column-readout circuit and the row-readout circuit reads the sensing voltage and outputs the sensing voltage as the image signal. In which, the timing of the exposure in the image sensing array and the timing of the readout in the readout circuit (the column-readout circuit and the row-readout circuit) are controlled by the timing control circuit.

In addition, the voltage values sensed by the image sensing array are so small that they are not easily read. Therefore, the readout circuit usually comprises the pre-amplify unit, used for amplifying the sensing voltage in readable range. The final image signals are usually amplified by the pre-amplify unit. The amplified image signal can be transferred to the controllable and storable digital image signal through the ADC.

The timing control circuit can be also integrated into the function of the micro processing unit 14. Namely, the micro processing unit 14 controls the exposure and readout of the CMOS image sensor 12.

Second, Linear Image Sensor:

The difference comparing to the image sensing array is that the linear image sensor can only sense the image signal of one dimension. The main application is the barcode-reading. Current barcode technology has been relatively popular and has relatively expansive application since the most business products have the barcodes.

The linear CMOS image sensor is composed of: a linear image sensor, a readout circuit, a timing control circuit and an ADC. Similarly, the output of the linear CMOS image sensor is analog image signal. The relationships between each device are described above and need not been mentioned again.

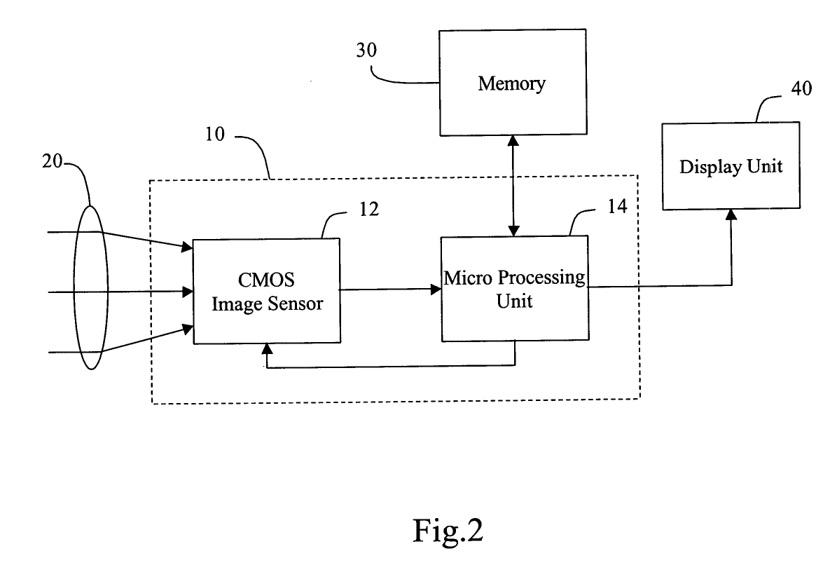

The practical applications of the present invention are referred in the following description. Please further refer to FIG. 2, it illustrates the first application example of the CMOS image sensor single chip integrated with the micro processing unit of the invention. The application example is the general case that the image data sensed by the CMOS image sensor 12 is displayed directly on the display unit 40. The memory 30 stores the image data sensed by the CMOS image sensor 12 through the micro processing unit 14. In addition, because the data capacities of the digital image data are very large in general, the image data is compressed in most case and then stored when needing to be stored. Therefore, for storing the digital image data, to assemble the image compression module in the micro processing unit 14 is needed.

However, to assemble the image compression module in the micro processing unit 14 and to display the compressed image data stored in the memory 30 of the display unit 40 connected to micro processing unit 14, the micro processing unit 14 needs to assemble the de-compression module simultaneously.

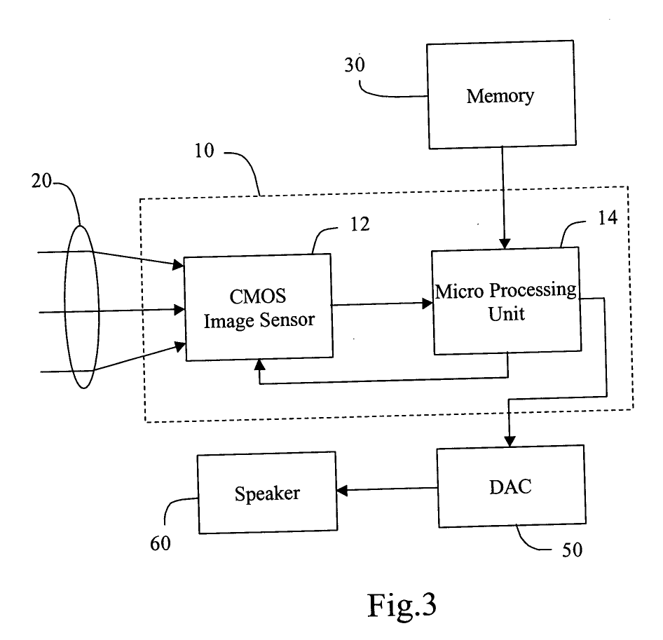

Please further refer to FIG. 3, it illustrates the second application example of the CMOS image sensor single chip integrated with the micro processing unit of the invention, which using the linear CMOS image sensor is better. Since the barcode-technology is well known and the usage of the barcode is popular, adopting the linear CMOS image sensor has the potential. In this application example, the present invention transforms the data read by barcode-reader to the voice output.

In another words, barcode information of original image data corresponds to a voice data stored in the memory 30. The coding method of the barcode can adopt the general barcode or special designed barcode. The voice data can adopt the current compression technology to reduce the capacities of the memory 30, or directly store in the memory without the voice compression technology as the larger capacities and lower cost of the memory in the future.

The memory 30 records the groups of voice data corresponding to the barcode information, and the digital voice data stored in the group of voice data is compression coded or un-compression coded. As using the voice compression technology, the memory 30 can adopt smaller capacity, instead, as without using the voice compression technology, the memory 30 need to adopt larger capacity °

On the application example, the micro processing unit 14 comprises the barcode decoding module and voice transforming module. The micro processing unit 14 receives the image data of the CMOS image sensor 12 and then transforms the sensed barcode pattern to the barcode information such as numbers. In following, the micro processing unit 14 corresponds the barcode information to the voice data in the memory 30 and then takes out and transmits the voice data to the ADC 50 to transform to be the analog voice data. The analog voice data can be broadcasted as the voice corresponding to the barcode pattern through the Speaker 60.

On the application example of the FIG. 3, each barcode is pre-determined to the corresponding voice data individually. The application example can be use for children toys, children voice books and language learning apparatus et al.

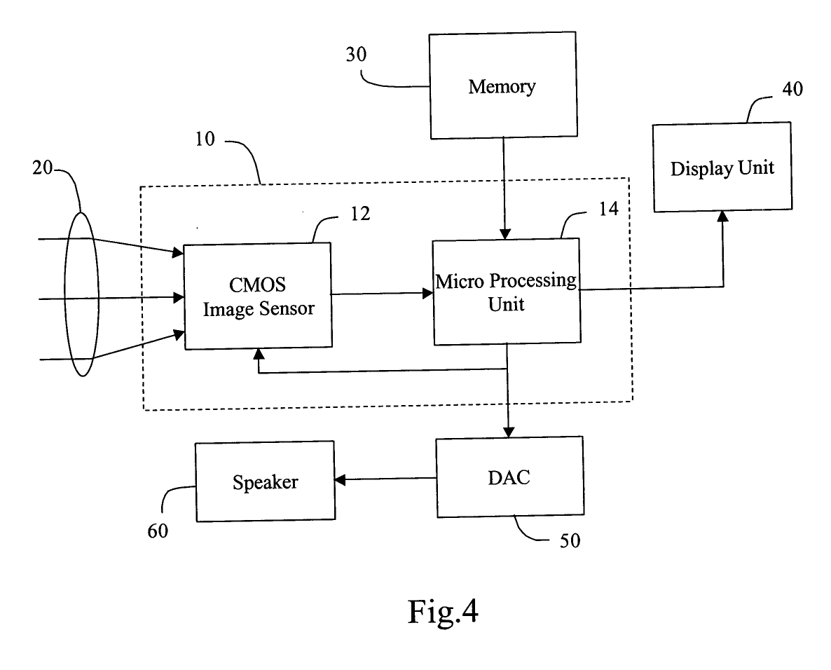

The first application example and the second application example can be further combined. Referring to FIG. 4, it illustrates the third application example of the CMOS image sensor single chip integrated with the micro processing unit of the invention, while the linear CMOS image sensor is used in this case.

On the application example, the micro processing unit 14 needs to include the barcode decoding module, the image processing module and the voice transforming module et al. The function is the integration of the above two application examples. Namely, after the micro processing unit 14 receives the barcode pattern sensed by the linear CMOS image sensor to further decoded as the barcode information, the voice information corresponding to the barcode information in the memory is taken out and outputted to the digital to analog converter (DAC) 50, and further outputted to the Speaker 60 as the voice. At the same time, the micro processing unit 14 takes out the barcode information corresponding to the image data in the memory and output to display in the display unit 40.

It is meant that the barcode pattern in this application example not only corresponds to voice data but also to other image data, relatively practical for child-toys and language learning.

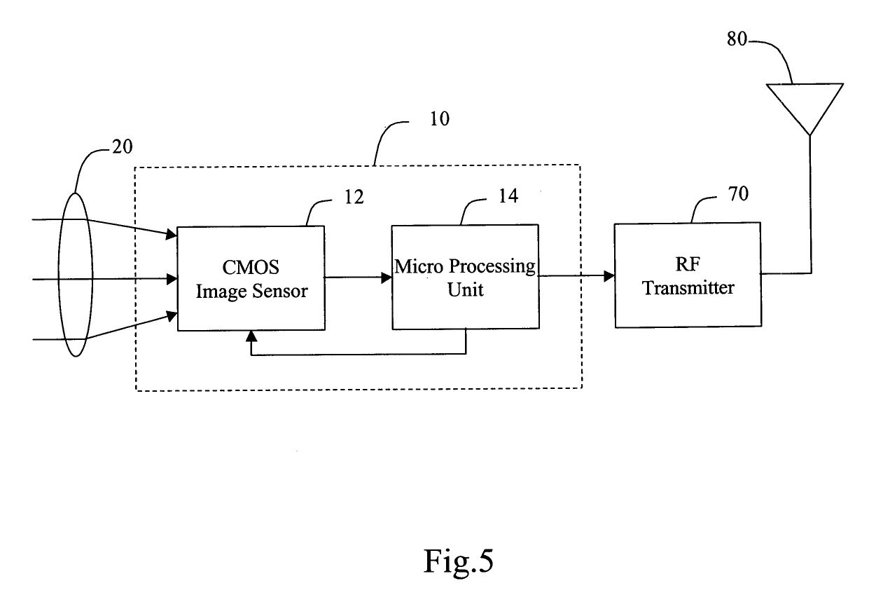

Another possibility of the application is referred to FIG. 5, illustrating the fourth application example of the CMOS image sensor single chip integrated with the micro processing unit of the invention. The application example integrates the micro processing unit 14 and the RF transmitter 70. So that, the digital image data processed by the micro processing unit 14 can be transmitted by the antenna 80 of the RF transmitter 70. However, to reduce the bandwidth of the RF transmitter 70 in this application example, there is a need to assemble the image compression module in the micro processing unit 14.

The practical frameworks in above-mentioned micro processing unit could adopt the frameworks of micro controller unit (MCU), microprocessor and digital processing processor (DSP).

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A CMOS image sensor single chip integrated with a mcro processing unit, comprising:
a complementary metal oxide semiconductor (CMOS) image sensor, used for detecting an input light as digital image signal; and
a micro processing unit, used for receiving said digital image signal which is further processed to be an application signal to be outputted.

2. The CMOS image sensor single chip integrated with a micro processing unit of claim 1, wherein said CMOS sensor comprises:
an image sensing array, used for receiving said input light and transferring said input light to a sensing voltage;
a readout circuit, used for reading said sensing voltage and outputting said sensing voltage as an analog image signal;
a timing control circuit, used for controlling working timing of said image sensing array and said readout circuit; and
an analog to digital converter, used for receiving said analog image signal and transferring said analog image signal to said digital image signal.

3. The CMOS image sensor single chip integrated with a micro processing unit of claim 2, wherein said readout circuit is formed of a column-readout circuit and a row-readout circuit.

4. The CMOS image sensor single chip integrated with a micro processing unit of claim 2, wherein said readout circuit further comprises a pre-amplify unit, used for amplifying said sensing voltage as said analog image signal.

5. The CMOS image sensor single chip integrated with a micro processing unit of claim 1, wherein said micro processing unit comprises an image compression module, used for compressing said digital image signal to be said application signal to reduce data capacity.

6. The CMOS image sensor single chip integrated with a micro processing unit of claim 1, wherein said micro processing unit comprises a image compression module, used for compressing said digital image signal to be said application signal to reduce data capacity, said micro processing unit further comprises a image de-compression module, used for de-compressing said compressed application signal to recover to be said digital image signal.

7. The CMOS image sensor single chip integrated with a micro processing unit of claim 1, wherein said CMOS image sensor is a linear CMOS image sensor.

8. The CMOS image sensor single chip integrated with a micro processing unit of claim 7, wherein said CMOS sensor comprises:
a linear CMOS image sensor, used for receiving said input light and transferring said input light to a sensing voltage;
a readout circuit, used for reading said sensing voltage and outputting said sensing voltage as an analog image signal;
a timing control circuit, used for controlling working timing of said image sensing array and said readout circuit; and
an analog to digital converter, used for receiving said analog image signal and transferring said analog image signal to said digital image signal.

9. The CMOS image sensor single chip integrated with a micro processing unit of claim 8, wherein said readout circuit further comprises a pre-amplify unit, used for amplifying said sensing voltage as said analog image signal.

10. The CMOS image sensor single chip integrated with a micro processing unit of claim 7, wherein said micro processing unit comprises a barcode-decoding module, used for decoding barcode pattern sensed by said CMOS image sensor to be said application signal.

11. The CMOS image sensor single chip integrated with a micro processing unit of claim 7, wherein said micro processing unit comprises a barcode-decoding module, used for decoding said barcode pattern sensed by said CMOS image sensor to be said application signal, taking out voice data of a outside voice memory connected with said micro processing unit corresponding to said application signal, and outputting said voice data to a digital to analog converter (DAC) to output to a microphone and transform to be a voice.

12. The CMOS image sensor single chip integrated with a micro processing unit of claim 7, wherein said micro processing unit comprises a barcode-decoding module, used for decoding said barcode pattern sensing by said CMOS image sensor to be said application signal, taking out voice data of a outside voice memory connected with said micro processing unit corresponding to said application signal, and outputting said voice data to a digital to analog converter (DAC), to output to a microphone and transform to be a voice; said micro processing unit further comprising a image processing module, used for taking out said image data corresponding to said application signal in said image memory connected outside said micro processing unit, to output to a display and transform to be displayed.

13. The CMOS image sensor single chip integrated with a micro processing unit of claim 1, wherein said micro processing unit is a micro controller unit (MCU).

14. The CMOS image sensor single chip integrated with a micro processing unit of claim 1, wherein said micro processing unit is a microprocessor.

15. The CMOS image sensor single chip integrated with a micro processing unit of claim 1, wherein said micro processing unit is a digital signal processor (DSP).

16. A CMOS image sensor single chip integrated with a micro processing unit, comprising:
a complementary metal oxide semiconductor(CMOS) image sensor, used for detecting an input light as digital image signal and
a micro processing unit, used for controlling exposure and readout time of said CMOS image sensor, and receiving said digital image signal which is further processed to be an application signal to be outputted.

17. The CMOS image sensor single chip integrated with a micro processing unit of claim 16, wherein said CMOS sensor comprises:
an image sensing array, used for receiving said input light and transferring said input light to a sensing voltage;
a readout circuit, used for reading said sensing voltage and outputting said sensing voltage as an analog image signal; and
an analog to digital converter, used for receiving said analog image signal and transferring said analog image signal to said digital image signal.

18. The CMOS image sensor single chip integrated with a micro processing unit of claim 17, wherein said readout circuit is formed of a column-readout circuit and a row-readout circuit, and said CMOS image sensor further comprises a timing control circuit which determines readout sequence of said readout circuit.

19. The CMOS image sensor single chip integrated with a micro processing unit of claim 17, wherein said readout circuit further comprises a pre-amplify unit, used for amplifying said sensing voltage as said analog image signal.
